(19) United States
(12) Patent Application Publication
(10) Pub. No.: US 2021/0030005 A1
(43) Pub. Date: Feb. 4, 2021

(54) BENZOXABOROLE COMPOSITIONS HAVING A GROWTH ENHANCING EFFECT

(71) Applicant: BORAGEN, INC., Durham, NC (US)

(72) Inventors: Chun Yu LIU, Durham, NC (US); Gregory Luke STEERE, Cary, NC (US)

(21) Appl. No.: 16/966,688

(22) PCT Filed: Jan. 31, 2019
(86) PCT No.: PCT/US2019/016036

§ 371 Date: Jul. 31, 2020

Related U.S. Application Data
(60) Provisional application No. 62/625,077, filed on Feb. 1, 2018.

(51) Int. Cl. A01N 55/08; C07F 5/02; A01N 43/54; A01N 43/40

(52) U.S. Cl. CPC A01N 55/08; A01N 43/40; A01N 43/54; C07F 5/025

(57) ABSTRACT

Benzoxaborole compounds and benzoxaborole compositions for increasing the growth of plants by inducing a growth enhancing effect within plants are described. Application of the compounds and/or composititons provides improved growth of treated plants, increases crop yield, improves quality, increases longevity of harvested parts thereof, and/or enhances nutrient content. In some embodiments, the benzoxaborole compounds or benzoxaborole compositions also display antimicrobial activity.

### CROSS REFERENCE TO RELATED APPLICATIONS

This application is an International application which claims priority to U.S. Provisional Application No. 62/625,077 filed on Feb. 1, 2018, the entire content of which is incorporated herein by reference.

### TECHNICAL FIELD

The present invention relates to benzoxaborole compounds and compositions that have antimicrobial activity and/or induce a growth enhancing effect within plants, the growth enhancing effect resulting in superior growth, increased crop yield, improved quality, increased longevity of harvested parts thereof, and/or enhanced nutrient content.

### BACKGROUND

Although the nature and activity of boric acid as a fertilizer is well known, as is the mobilization of boric acid within a plant, the corresponding activity and mobilization of benzoxaboroles as plant growth enhancers have heretofore been unknown. While the antimicrobial activities of some benzoxaboroles has been taught (see Publication No. WO2016128949 (antimicrobial), U.S. Pat. No. 9,617,285 (antiparasitic), and Publication No. WO2016164589 (antifungal)), the plant growth enhancing activity of benzoxaboroles has not been demonstrated. Interestingly, while water soluble boric acids or borate complexes have been used as fertilizers, those compounds fail to exhibit good antimicrobial activities. In contrast, benzoxaboroles, and oxaboroles, are not readily water soluble due to their more hydrocarbon or organic compound-like characteristics. Likewise, many benzoxaboroles are highly potent antimicrobial agents. The activity of oxaboroles and benzoxaboroles in inducing a growth effect, however, is unknown.

Boron is a unique, and often misconstrued, element of the periodic table due to its capacity to create both powerfully effective and potentially toxic compounds. While the use of boron as boric acid is well known, the construction and characterization of more complex boron-containing compounds that have low toxicity and are effective has been relatively uninvestigated. Only recently have skilled organo-metallic chemists begun to explore boron-containing compounds for novel and useful applications across human/animal health and agriculture. For example, boron-containing molecules such as oxaboroles and benzoxaboroles have demonstrated use as antimicrobials, antiparasitics, and antifungals. (see Publication No. WO2016128949 (antimicrobial), U.S. Pat. No. 9,617,285 (antiparasitic), and Publication No. WO2016164589 (antifungal)).

It is known that boron is mainly mobilized with the flow of water through the xylem from the roots to the leaves. Because boron deficiency symptoms are found in the growing tissues, plants are often sensitive to short term boron deficiencies, which can occur rapidly. Traditional, foliar fertilization provides limited value because it is restricted to the sprayed tissues and will not be available to new growth. Most crops exhibit very little control in boron uptake and, consequently, boron accumulation is directly related to transpiration and soil boron availability.

While the micronutrient impact of some boron-containing compounds in plants is known, not all boron-containing compounds can impart this growth enhancing effect. The specific biological activity (whether it has antimicrobial, growth enhancing, herbicidal or other activities) of a boron-containing compound depends on the structure of the molecule itself. There are boron containing herbicidal compounds that impart harmful/negative effects on plant growth and vigor (see Patent No. DE 1,016,978, U.S. Pat. Nos. 2,551,705, and 2,580,474). Many of the herbicidal boron compounds are less water soluble than that of the boric acids/borates that are commonly used as fertilizer.

The above examples demonstrate that the creation and development of such boron-containing compounds has proven to be unpredictable; even in the hands of experts, boron containing scaffolds present compounds that must then be tested from toxicology, mode of action, and activity perspective. The duplicitous nature of boron-containing compounds places their activity on a broad continuum; including those that are highly toxic, and those that are exceptionally benign. Benzoxaboroles can be created that either have, antimicrobial, herbicidal, or growth enhancing activity or combinations of the preceding. Thus, creation of novel and useful boron-containing compounds requires skilled attention to design, synthesis, formulation, as well as thoughtful evaluation of toxicity, mode of action, and efficacy.

Additionally, boron's ability to covalently bond with other molecules makes it both attractive and difficult to work with. Boron-containing molecules traditionally have suffered in becoming commercially viable products due to synthetic and pharmacological uncertainties. However, in the right hands, these characteristics can be leveraged, to make great impact in the area of crop protection.

While some benzoxaboroles have been demonstrated to exhibit antimicrobial and/or growth enhancing activities, they have not been successfully employed as a commercial product for crop protection and agriculture pest-control. One reason may be the fluxional and reactive nature of benzoxaboroles; benzoxaboroles can exist in a neutral trigonal planar geometry, an ionic tetrahedral geometry, or a mixture of both of these geometries depending on the specific environment the benzoxaborole is in. Further, this difference in formal charge (neutral vs. ionic) and geometry (trigonal vs. tetrahedral) can greatly affect the biological activity of the benzoxaborole. For example, each benzoxaborole geometry can bind to a target protein differently, and the charge (neutral vs. ionic) can influence the cell permeability. Depending on the geometry and charge of the benzoxaborole, the benzoxaborole can ultimately be an effective, potent compound, or a compound that shows little or no bioactivity.

Further complicating matters, the charge and geometry of the benzoxaborole is not static in some environments. Rather, the benzoxaborole can exist in a fluxional state, wherein the compound is in a dynamic equilibrium between the neutral trigonal planar state, and the ionic tetrahedral state (Scheme 1). Moreover, substitutions on the benzoxaborole can have profound effects on this dynamic equilibrium. Additionally, the boron atom's empty p-orbital readily forms covalent bonds with Lewis bases that may potentially affect biological activity. These characteristics together make the development of benzoxaborole compounds that display growth enhancing effects an unpredictable and challenging endeavor.

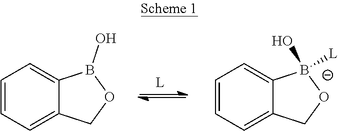

As stated above, it is well known that plants require an adequate supply of available boron, especially during flowering and seed development. Boric acid was first registered as a pesticide by the EPA in 1948, and in 1993, 189 pesticide products containing boric acid or one of its sodium salts were registered. (see EPA-738-F-93-006m R.E.D. Facts, September 1993). The EPA has acknowledged the low toxicity of boric acid and it usefulness in the agricultural industry. (Id.). Moreover, Davis et al, have shown that the application of boric acid as hydroponic fertilizer results in increased growth of the plant, plant parts, and plant propagation materials. (Davis, et al. Boron Improves Growth, Yield, Quality, and Nutrient Content of Tomato. J. Amer. Soc. Hort. Sci. 128(3): 441-446 2003). That study also taught that boric acid application can result in higher yield and longer shelf-life for harvested tomatoes. It should be noted that boric acid (H₃BO₃) is a simple and highly water-soluble entity that lacks any hydrophobic components that are usually found in more complex organic compounds composed of hydrocarbons. For more complex, organic compounds, it is possible that the chemical component effecting growth enhancing activity is the boron-containing compound (e.g. a benzoxaborole) or a boron-containing fragment (i.e., the active boron fragment) of the boron-containing compound. As a result, the biological activity will depend on whether or not the active boron fragment is sequestered/trapped within the boron-containing compound or how tightly the active boron fragment is sequestered/trapped within the boron-containing compound. Furthermore, some of the boron-containing compounds might decompose or degrade into nonproductive boron-containing compounds, making the boron either not bioavailable to the plants or toxic (i.e. herbicidal effect) to the plants.

Thus, the bioavailability of the active boron fragment and/or the boron-containing compound is important for the biological activity. Accordingly, the unique bonding attributes of boron need to be carefully and rationally considered in designing a biologically active boron-containing compound. Further, there is the possibility that a boron-containing compound could be designed and paired with another associated compound to which the boron-containing compound reversibly binds. In this scenario, the boron-containing compound could be released from its second associated compound in a time dependent manner, creating a controlled release of the boron-containing compound.

As stated above, the unpredictable nature of boron complicates the design and creation of safe and effective products for agricultural use. Moreover, boron-containing compounds, including benzoxaboroles, may have more than one target, for more than one purpose (e.g., antibacterial, antifungal, antimicrobial, pesticidal, insecticidal, enhanced plant growth, post-harvest, etc.), and the specific biological activity of the benzoxaborole will depend on the specific molecular structure of the benzoxaborole (e.g., the different chemical groups attached to the core benzoxaborole scaffold). Thus, it is contemplated that specific groups of benzoxaboroles, when applied to a plant, may provide a growth enhancing effect that includes advantageous post-harvest properties.

There is a need for compounds and compositions comprising boron-containing compounds, specifically benzoxaboroles, that can be used to enhance the growth of plants, plant parts, and/or plant propagation materials, increases crop yield, enhances nutrient content and/or increases the longevity of the harvested parts thereof, as well as exhibiting antimicrobial activity.

### BRIEF SUMMARY OF THE INVENTION

Described herein are benzoxaborole compounds and benzoxaborole compositions that induce a growth enhancing effect within plants, which results in superior growth of these treated plants, increases crop yield, improves quality, increases longevity of harvested parts thereof, and/or enhances nutrient content. In some embodiments, the benzoxaborole compounds or benzoxaborole compositions also display antimicrobial activity.

The compounds and/or compositions described herein may be administered systemically, topically, in the soil, as a seed treatment, or to the foliage. The composition comprises a benzoxaborole (also referred to herein as benzoxaborole compound) and an inert carrier. The compound and inert carrier can be formulated in a known manner to make commonly used forms such as emulsifiable concentrates, coatable pastes, sprayable or dilutable solutions, dilute emulsions, wettable powders, soluble powders, dusts, granulates, and encapsulations. The composition may also comprise further adjuvants such as stabilizers, antifoams, viscosity regulators, binders or tackifiers, or other formulations for obtaining desired effects. The composition may also further comprise additional active ingredients, for example, fertilizers, herbicides, insecticides fungicides, etc. The application of the compound or the composition may be: topical, to the soil, foliar, a foliar spray, systemic, a seed coating, a seed treatment, a soil drench, directly in-furrow dipping, drenching, soil drenching, spraying, atomizing, irrigating, evaporating, dusting, fogging, broadcasting, foaming, painting, spreading-on, watering (drenching), or drip irrigating, or any combinations thereof. Administration may be hydroponic or aeroponic in nature.

The compounds and/or compositions for increasing the growth of plants can include combinations of active ingredients, biologics, extracts, or other additives.

The compounds and/or compositions for increasing the growth of plants, plant parts, plant propagation materials, and/or fruits harvested therefrom, can be applied by spraying, atomizing, dusting, scattering, coating, or pouring.

The compounds and/or compositions may be administered systemically, topically, in the soil, as a seed treatment, or to the foliage. The compositions of the present invention may have anti-pathogenic activity (e.g., insecticidal, nematicidal, fungicidal, antimicrobial, etc.) in addition to the growth enhancing effect. Thus, such compositions have dual functions to positively affect plant health.

The compounds and/or compositions for the growth enhancement of plants, plant parts, plant propagation materials, and/or fruits harvested therefrom may have an additional antimicrobial effect. In some embodiments, the compounds and/or compositions have fungicidal effects.

Moreover, application of a compound and/or composition for the growth enhancement of plants, plant parts, plant propagation materials may result in increased vigor in those plant, plant parts, plant propagation materials, and/or fruits harvested therefrom.

Application of a compound and/or composition for the growth enhancement of plants, plant parts, plant propagation materials may result in increased post-harvest quality and/or longevity in those plant, plant parts, plant propagation materials, and/or fruits harvested therefrom.

Application of a compound and/or composition for the growth enhancement of plants, plant parts, plant propagation materials may result in increased size or mass of those plant, plant parts, plant propagation materials, and/or fruits harvested therefrom relative to untreated plants.

Application of a compound and/or composition for the growth enhancement of plants, plant parts, plant propagation materials may result in increased yield of those plant, plant parts, plant propagation materials, and/or fruits harvested therefrom.

Application of a compound and/or composition for the growth enhancement of plants, plant parts, plant propagation materials may result in increased resistance to biotic and abiotic stresses in those plant, plant parts, plant propagation materials, and/or fruits harvested therefrom.

Application of a compound and/or composition for the growth enhancement of plants, plant parts, plant propagation materials may result in increased root size or root mass in those plant, plant parts, plant propagation materials, and/or fruits harvested therefrom.

The compositions may comprise a boron-containing compound (e.g. a benzoxaborole) and an associate compound, whereby the associate compound binds to the boron-containing compound in a reversible manner, and provides a sustained release of the boron-containing compound to the plant, plant parts, plant propagation materials, and/or fruits harvested therefrom.

The compounds and/or compositions may be applied in conjunction with a fertilizer treatment. The compounds and/or compositions of the present invention may enhance the growth of the plant, plant parts, plant propagation materials, and/or fruits harvested therefrom.

The compounds and/or compositions may provide an improved growth enhancing effect relative to traditional fertilizer or plant stimulant regimens.

The benzoxaborole compounds and/or compositions may be applied in combination with a fertilizer treatment. Such combinations of the present invention reduce the amount of applied fertilizer components that are needed to obtain the desired effect, as compared to traditional fertilizer application. Such benzoxaborole compounds and/or compositions and fertilizer treatment combinations achieve the desired affect (level of biological response) with a reduced rate of fertilizer compared to fertilizer alone.

The preceding is a simplified summary to provide an understanding of some embodiments of the present disclosure. This summary is neither an extensive nor exhaustive overview of the present disclosure and its various embodiments. The summary presents selected concepts of the embodiments of the present disclosure in a simplified form as an introduction to the more detailed description presented below. As will be appreciated, other embodiments of the present disclosure are possible utilizing, alone or in combination, one or more of the features set forth above or described in detail below.

### DETAILED DESCRIPTION

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

As used herein, the term “hydrocarbyl” is a short hand term for a non-aromatic group that includes straight and branched chain aliphatic as well as alicyclic groups or radicals that contain only carbon and hydrogen. Inasmuch as alicyclic groups are cyclic aliphatic groups, such substituents are deemed to be subsumed within the aliphatic groups. Thus, alkyl, alkenyl, and alkynyl groups are contemplated.

Exemplary hydrocarbyl groups contain a chain of 1 to about 6 carbon atoms, and more preferably 1 to 4 carbon atoms. Examples of hydrocarbyl radicals include methyl (Me), ethyl (Et), n-propyl (n-Pr), isopropyl (i-Pr), n-butyl (n-Bu), isobutyl (i-Bu), sec butyl (sec-Bu), tert-butyl (t-Bu), pentyl (n-Pen), iso-amyl, hexyl, and the like. Examples of suitable alkenyl radicals include ethenyl (vinyl), 2 propenyl, 3 propenyl, 1,4-pentadienyl, 1,4 butadienyl, 1-butenyl, 2-butenyl, 3-butenyl, and the like. Examples of alkynyl radicals include ethynyl, 2-propynyl, 3 propynyl, decynyl, 1 butynyl, 2-butynyl, 3-butynyl, and the like.

An alkyl group is a preferred hydrocarbyl group. As a consequence, a generalized, but more preferred substituent can be recited by replacing the descriptor “hydrocarbyl” with “alkyl” in any of the substituent groups enumerated herein. Where a specific aliphatic hydrocarbyl substituent group is intended, that group is recited; i.e., C1-C4 alkyl, methyl, or dodecenyl.

A contemplated cyclohydrocarbyl substituent ring contains 3 to 6 carbon atoms. The term “cycloalkylalkyl” means an alkyl radical as defined above that is substituted by a cycloalkyl radical. Examples of such cycloalkyl radicals include cyclopropyl, cyclobutyl, cyclopentyl, cyclohexyl, and the like.

Usual chemical suffix nomenclature is followed when using the word “hydrocarbyl” except that the usual practice of removing the terminal “yl” and adding an appropriate suffix is not always followed because of the possible similarity of a resulting name to that of one or more substituents. Thus, a hydrocarbyl ether is referred to as a “hydrocarbyloxy” group rather than a “hydrocarboxy” group as may possibly be more proper when following the usual rules of chemical nomenclature. Illustrative hydrocarbyloxy groups include methoxy, ethoxy, and cyclohexenyloxy groups. On the other hand, a hydrocarbyl group containing a C(O)— functionality is referred to as a hydrocarboyl (acyl) and that containing a —C(O)O— is a hydrocarboyloxy group inasmuch as there is no ambiguity. Exemplary hydrocarboyl and hydrocarboyloxy groups include acyl and acyloxy groups, respectively, such as formyl, acetyl, propionyl, butyryl, valeryl, 4 methylvaleryl, and acetoxy, acryloyl, and acryloyloxy.

The term “halogen” or “halo” means fluorine, chlorine, bromine, or iodine. The term “halohydrocarbyl” means a hydrocarbyl radical as defined above wherein one or more hydrogens is replaced with a halogen. A halohydrocarbyl radical (group or substituent) is typically a substituted alkyl substituent. Examples of such haloalkyl radicals include chloromethyl, 1-bromoethyl, fluoromethyl, difluoromethyl, trifluoromethyl, 1,1,1-trifluoroethyl, and the like.

The term “perfluorohydrocarbyl” means an alkyl group wherein each hydrogen has been replaced by a fluorine atom. Examples of such perfluorohydrocarbyl groups, in addition to trifluoromethyl above, are perfluorobutyl, perfluoroisopropyl, and perfluorohexyl.

The term “plant health” generally describes various sorts of characteristics of plants that are not connected to the control of pests or artificial fertilization. For example, properties that may be mentioned are crop characteristics including: emergence, crop yields, protein content, oil content, starch content, root system, root growth, root size maintenance, stress tolerance (e.g. against drought, heat, salt, UV, water, cold), ethylene (production and/or reception), tillering, plant height, leaf blade size, number of basal leaves, tillers strength, leaf color, pigment content, photosynthetic activity, amount of input needed (such as fertilizers or water), seeds needed, tiller productivity, time to flowering, time to grain maturity, plant verse (lodging), shoot growth, plant vigor, plant stand, tolerance to biotic and abiotic stresses, natural defense mechanisms, and time to germination.

The term “growth enhancement effect” generally describes various sorts of growth related improvements to the health and/or vitality of plants that are not connected to the control of pests or artificial fertilization. For example, advantageous improvements that may be mentioned are improved crop characteristics including: shorter time to emergence, increased crop yields, increased protein content, increased oil content, increased starch content, more developed root system, improved root growth, improved root size maintenance, abiotic stress tolerance (e.g. against drought, heat, salt, UV, water, cold), reduced ethylene (reduced production and/or inhibition of reception), tillering increase, increase in plant height, bigger leaf blade, less dead basal leaves, stronger tillers, greener leaf color, increased chlorophyll levels, increased photosynthetic activity, less input needed (such as fertilizers or water), less seeds needed, more productive tillers, earlier flowering, early grain maturity, less plant lodging, increased shoot growth, enhanced plant vigor, increased plant stand, increased tolerance to abiotic stresses, activation of natural defense mechanisms, and early and better germination. The term “growth enhancement effect” may also refer to increases in yield, longer shelf stability/viability of the plant or plant products, increased vigor, and the like.

The term “plant stimulant” as used herein refers to a compound, composition, microorganism, substance, or any combination thereof that when applied to a plant, seed, soil or any other substrate enhances the health and growth of a plant by stimulating the natural processes of plants to benefit their nutrient use efficiency and/or tolerance to stress, regardless of its nutrient content, or any combination of such substance and/or microorganisms intended for this use. Plant stimulants can be synthetic, natural, or naturally derived. Therefore, a plant stimulant might be a chemical compound, a natural product isolated from a living organism, or an microorganism such as a fungi, bacterium, or other microbe.

In general, “pesticidal” means the ability of a substance to increase mortality or inhibit the growth rate of plant pests. The term is used herein, to describe the property of a substance to exhibit activity against insects, mites, nematodes, fungi, bacteria, viruses, and/or phytopathogens. The term “pests” include insects, mites, nematodes, fungi, bacteria, viruses, and/or phytopathogens.

By “effective” amount of an active ingredient, compound, composition, drug, formulation, or permeant is meant a sufficient amount of a compound, a composition, or an active agent to provide the desired local or systemic growth enhancing effect.

The term “agriculturally acceptable salt” is meant to include a salt of a compound of the invention which are prepared with relatively nontoxic acids or bases, depending on the particular substituents found on the compounds described herein. When compounds of the invention contain relatively acidic functionalities, base addition salts can be obtained by contacting the neutral form of such compounds with a sufficient amount of the desired base, either neat or in a suitable inert carrier. Examples of agriculturally acceptable base addition salts include sodium, potassium, calcium, ammonium, organic amino (such as choline or diethylamine or amino acids such as d-arginine, 1-arginine, d-lysine, or 1-lysine), or magnesium salt, or a similar salt. When compounds of the invention contain relatively basic functionalities, acid addition salts can be obtained by contacting the neutral form of such compounds with a sufficient amount of the desired acid, either neat or in a suitable inert solvent. Examples of pharmaceutically acceptable acid addition salts include those derived from inorganic acids like hydrochloric, hydrobromic, nitric, carbonic, monohydrogencarbonic, phosphoric, monohydrogenphosphoric, dihydrogenphosphoric, sulfuric, monohydrogensulfuric, hydriodic, or phosphorous acids and the like, as well as the salts derived from relatively nontoxic organic acids like acetic, propionic, isobutyric, maleic, malonic, benzoic, succinic, suberic, fumaric, lactic, mandelic, phthalic, benzenesulfonic, p-tolylsulfonic, citric, tartaric, methanesulfonic, and the like. Also included are salts of amino acids such as arginate and the like, and salts of organic acids like glucuronic or galactunoric acids and the like (see, for example, Berge et al., “Pharmaceutical Salts”, Journal of Pharmaceutical Science 66: 1-19 (1977)). Certain specific compounds of the invention contain both basic and acidic functionalities that allow the compounds to be converted into either base or acid addition salts.

The term “agriculturally acceptable carrier” or “agriculturally acceptable vehicle” refers to any medium that provides the appropriate delivery of an effective amount of an active agent(s) as defined herein, does not negatively interfere with the effectiveness of the biological activity of the active agent, and that is sufficiently non-toxic to the host. Representative carriers include water, oils, both vegetable and mineral, cream bases, lotion bases, emulsion bases, ointment bases and the like. These bases include suspending agents, thickeners, penetration enhancers, and the like. Additional information concerning carriers can be found in Remington: The Science and Practice of Pharmacy, 21st Ed., Lippincott, Williams & Wilkins (2005), which is incorporated herein by reference.

The term “agriculturally acceptable excipient” is conventionally known to mean agriculturally acceptable carriers, agriculturally acceptable diluents and/or agriculturally acceptable vehicles used in formulating compositions effective for the desired use.

The term “carrier” is used herein to denote a natural or synthetic, organic, or inorganic material that constitutes a portion of the diluent medium in which the benzoxaborole is dispersed or dissolved. This carrier is inert and agriculturally acceptable, in particular to the plant being treated. The phrase “agriculturally acceptable” is utilized herein to be analogous to “pharmaceutically acceptable” as used in pharmaceutical products to describe diluent media. A carrier can be solid (clays, natural or synthetic silicates, silica, resins, waxes, solid fertilizers, dusts and dispersible powders such as kaolinite, lactose, calcite, talc, kaolin, bentonite, or other absorptive polymers, and the like) or liquid (water, alcohols, ketones, petroleum fractions, aromatic or paraffinic hydrocarbons, chlorinated hydrocarbons, liquefied gases, and the like).

The term “vigor” is the measure of the increase in plant growth or foliage volume through time after planting.

The term “yield” is the total agronomic output of a planted area; for example, standing crop expressed as a rate (grams dry weight per square meter per day) or grain harvested per grain planted.

The term “post harvest” is the stage of crop production immediately following harvest, including cooling, cleaning, sorting and packing. The instant a crop is removed from the ground, or separated from its parent part, it begins to deteriorate.

The term “antimicrobial” means a compound that kills microorganisms or stops their growth.

The term “fertilizer” means a chemical or natural substance added to soil or land to increase its fertility. For example, in corn typical fertilizer applications begin with a pre-plant application, an at-planting application and an optional mid-season application. Time-points for fertilizer application are dependent on nitrogen, phosphorous, and potassium levels found in the plant after sampling. Older forms of fertilizing use traditional granular products, at various ratios of nitrogen, phosphorous and potassium, but liquid fertilizers can be combined at different levels to achieve the application of various rates of nitrogen, phosphorus, and potassium, as is well known in the art. One skilled in the art is aware of other durations between other fertilizer types.

The benzoxaborole compounds and compositions described herein have several benefits and advantages.

In one embodiment, the benzoxaborole compound has a structure, (I):

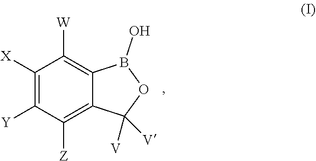

wherein:
W is selected from the group consisting of: hydrogen, halogen, CH₃, CF₃, Et, OCH₃, OCF₃, OCF₂H, CFH₂, OEt, SR¹, and S(O)R¹, wherein R¹ is selected from C1-C3 hydrocarbyl;
X is selected from the group consisting of: hydrogen, R², OR², NR²₂, NHR², NH₂, halogen, CO₂R², CN, OH, CH₂OH, NO₂, SR², and S(O)R²,
   wherein each R² is independently selected from C1-C5 hydrocarbyl and C3-C5 cyclohydrocarbyl;
Y is selected from the group consisting of: hydrogen, halogen, and CO₂R³, wherein R³ is selected from C1-C4 hydrocarbyl and C3-C4 cyclohydrocarbyl;
Z is selected from the group consisting of: hydrogen, halogen, R⁴, NR⁴₂, NHR⁴, NH₂, CO₂R⁴, OR⁴, OH, SR⁴, and S(O)R⁴, wherein R⁴ is selected from C1-C3 hydrocarbyl and C3 cyclohydrocarbyl; and
V and V′ are independently selected from the group consisting of hydrogen and CH₃,
or a salt, agricultural chemical salt, pharmaceutical salt, stereoisomer, enantiomer, or tautomer thereof.

In a preferred embodiment, the benzoxaborole has a structure (Ia):

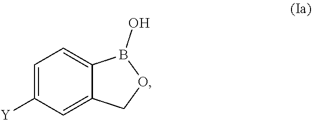

wherein Y is halogen,
or a salt, agricultural chemical salt, pharmaceutical salt, stereoisomer, enantiomer, or tautomer thereof.

In a feature of this embodiment, Y is chlorine.

In another preferred embodiment, the benzoxaborole has a structure (Ib):

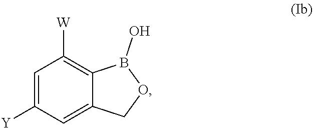

wherein Y and W are halogen and independently selected from the group consisting of: fluorine, chlorine, bromine, and iodine,
or a salt, agricultural chemical salt, pharmaceutical salt, stereoisomer, enantiomer, or tautomer thereof.

In embodiments of the present invention, compositions comprising benzoxaboroles of structure I, Ia, and/or Ib, with other compounds such as surfactants, sugars, amino acids, and the like, provide an enhanced growth effect to plants, plant parts, and/or plant propagation materials.

The term “associate compound” refers to a different compound from the benzoxaborole of structure I, Ia, and/or Ib. An associate compound includes those compounds that may bond to the compound of structure I, Ia, and/or Ib in a fluxional state. The associate compound may bind to the boron-containing compound in a reversible manner, and may provide a sustained release of the boron-containing compound to a plant, plant parts, plant propagation materials, and/or fruits harvested therefrom. Exemplary associate compounds may include diols, sugars, alcohols, amino acids, diamines, and compounds that include an amine and an alcohol (for example, alkanolamines). Preferred associate compounds include diols and sugars.

The compounds and compositions described herein can induce growth enhancing effects within plants, which result in, for example, superior growth of treated plants, increased crop yield, improved quality, increased longevity of harvested parts thereof, and/or enhanced nutrient content. Multiple parameters can be measured to determine and quantify the presence of growth enhancing effects. The parameters may vary based on the plant being grown. For example, the following exemplary parameters can be measured, compared, and analyzed: shoot height, root length, stem length, dry matter weight, and yield.

As will be shown in the examples section, application of the benzoxaborole compounds and/or compositions described herein can provide significant increases in final dry matter weight of produced plants. For example, dry matter weight may increase by up to 50%, up to 100%, up to 150%, up to 200%, up to 250%, and up to 300%. The increase in dry matter weight may be from 25%-300%, 50%-250%, 100%-300%, 100%-250%, and 150%-250%. In another example, application of the benzoxaborole compositions described herein can provide increases in root length and stem length of produced plants. For example, root length may be increased by up to 25%, up to 50%, and up to 80%. The increase in root length may be from 10% to 80%, from 20% to 75%, from 40% to 70%, and from 50% to 70%. The root length may be increased by 10%, 20%, 30%, 40%, 50%, 55% 60%, 65%, 70%, 75% or 80%. For example, stem length may be increased by up to 25%, up to 50%, and up to 80%. The increase in stem length may be from 10% to 80%, from 20% to 75%, from 40% to 70%, and from 50% to 70%. The stem length may be increased by 10%, 20%, 30%, 40%, 50%, 55%, 60%, 65%, 70%, 75% or 80%. As it pertains to crop growth, the compounds and/or compositions may be applied in any desired manner, such as in the form of a seed coating, soil drench, and/or directly in-furrow and/or as a foliar spray and applied either pre-emergence, post-emergence, or both. In other words, the compounds and/or compositions can be applied to the seed, the plant or to harvested fruits and vegetables or to the soil wherein the plant is growing or wherein it is desired to grow (plant's locus of growth).

As will be appreciated, compositions can be applied in varying concentrations and at varying rates. In embodiments, higher application rates provide greater growth enhancing effects. One skilled in the art can determine a suitable rate for achieving an intended effect on an intended crop.

The compounds and compositions for increasing the growth of plants described herein may further comprise a diluent medium or a carrier and may be conveniently formulated in a known manner to emulsifiable concentrates, coatable pastes, directly sprayable or dilutable solutions, dilute emulsions, emulsions, wettable powders, soluble powders, dusts, granulates, and/or encapsulations, e.g. in polymeric substances. As with the type of the compositions, the methods of application, such as spraying, atomizing, dusting, scattering, coating or pouring, are chosen in accordance with the intended objectives and the prevailing circumstances. A contemplated composition can also contain further adjuvants such as stabilizers, antifoams, viscosity regulators, binders, or tackifiers, as well as fertilizers, micronutrient donors, or other compositions for obtaining special effects.

Suitable diluent media and adjuvants (auxiliaries) can be solid or liquid and are substances useful in formulation technology, e.g. natural or regenerated mineral substances, solvents, dispersants, wetting agents, tackifiers, thickeners, binders, or fertilizers. Such diluent media are, for example, described in WO 97/33890, which is hereby incorporated by reference. Water-based (more than 50 weight percent water) diluent media are presently preferred and are used illustratively herein.

More particularly, a contemplated formulation of the composition can be employed in any conventional form, for example, in the form of a powder, an emulsion, a flowable concentrate, a solution, a water dispersible powder, a capsule suspension, a gel, a cream, an emulsion concentrate, a suspension concentrate, a suspo-emulsion, a capsule suspension, a water dispersible granule, an emulsifiable granule, a water in oil emulsion, an oil in water emulsion, a micro-emulsion, an oil dispersion, an oil miscible liquid, a soluble concentrate, an ultra-low volume suspension, an ultra-low volume liquid, a technical concentrate, a dispersible concentrate, a wettable powder, or any technically feasible formulation.

The benzoxaborole compositions described herein can be produced by one of skill in the art, e.g. by mixing the benzoxaborole compounds with appropriate formulation inerts that comprise the diluent medium such as solid or liquid carriers and optional other formulating ingredients such as surface-active compounds (surfactants), biocides, anti-freeze agents, stickers, thickeners and compounds that provide adjuvancy effects, and the like. Also, conventional slow release formulations can be employed where long-lasting efficacy is intended. Particularly, formulations to be applied in spraying forms, such as water dispersible concentrates, wettable powders, and granules, can contain surfactants such as wetting and dispersing agents and other compounds that provide adjuvancy effects, e.g., the condensation product of formaldehyde with naphthalene sulphonate, an alkylarylsulphonate, a lignin sulphonate, a fatty alkyl sulphate, ethoxylated alkylphenol, trisiloxane ethoxylate, and an ethoxylated fatty alcohols.

In typical use, a commercial product of the growth enhancing benzoxaborole composition is formulated as a concentrate (or concentrate, formulated compound, or formulation), and the end user normally employs a diluted formulation or an applied formulation for administration to the plants of interest. Such a diluted composition is often referred to as a tank-mix composition or an applied formulation. A tank-mix composition or applied formulation is generally prepared by diluting a formulation containing benzoxaborole with a carrier such as water that can optionally also contain further auxiliaries. Generally, an aqueous tank-mix is preferred.

Suitable penetrants that may be used in the present context include all those substances which are typically used in order to enhance the penetration of active agrochemical compounds into plants. Penetrants in this context are defined in that, from the (generally aqueous) application liquor and/or from the spray coating, they are able to penetrate the cuticle of the plant and thereby increase the mobility of the active compounds in the cuticle. This property can be determined using the method described in the literature (Baur et al., 1997, Pesticide Science 51, 131-152). Examples include alcohol alkoxylates such as coconut fatty ethoxylate (10) or isotridecyl ethoxylate (12), fatty acid esters such as rapeseed or soybean oil methyl esters, fatty amine alkoxylates such as tallowamine ethoxylate (15), or ammonium and/or phosphonium salts such as ammonium sulphate or diammonium hydrogen phosphate, for example.

The benzoxaborole compositions (formulations) that induce growth enhancing effects within plants, which results in superior growth of the treated plants, increases crop yield, improves quality, increases longevity of harvested parts thereof, and/or enhances nutrient content preferably comprises between 0.00000001% and 98% by weight of benzoxaborole or, with particular preference, between 0.01% and 95% by weight of benzoxaborole, more preferably between 0.5% and 90% by weight of benzoxaborole, based on the weight or volume of the formulation. For example, the formulation may comprise between 1% and 80%, 2% and 70%, 5% and 60%, 5% and 50%, and 5% and 40% by weight of benzoxaborole, with the balance being one or more suitable agrochemically acceptable ingredients.

The active boron fragment of the application forms prepared from the formulations may vary within wide ranges. Exemplary application forms may include a seed coating, soil drench, and/or directly in-furrow and/or as a foliar spray. The benzoxaborole concentration of the application forms may be situated typically between 0.00000001% and 95% by weight of benzoxaborole. For example, between 0.00001% and 50%, between 0.00001% and 40%, between 0.00001% and 30%, between 0.00001% and 20%, between 0.00001% and 10%, preferably between 0.00001% and 5% by weight, based on the weight of the application form. Application takes place in a customary manner adapted to the application form.

In another aspect of the present invention, the compounds and/or compositions that induce growth enhancing effects within plants, which results in superior growth of these treated plants, increases crop yield, improves quality, increases longevity of harvested parts thereof, and/or enhances nutrient content as described above are used for reducing overall damage of plants and plant parts, as well as losses in harvested fruits or vegetables caused by bacteria, fungi, insects, mites, nematodes, viruses, and/or phytopathogens.

Furthermore, in another aspect of the present invention, the compounds and compositions as described above increase overall plant health.

If not mentioned otherwise, the treatment of plants or plant parts (which includes seeds and plants emerging from the seed), harvested fruits and vegetables, with the compounds and/or compositions for increasing the growth of plants, are carried out directly or by action on their surroundings, habitat or storage space using customary treatment methods, for example dipping, spraying, atomizing, irrigating, evaporating, dusting, fogging, broadcasting, foaming, painting, spreading-on, watering (drenching), and/or drip irrigating. It is furthermore possible to apply the compounds and/or composition as sole-composition or combined-compositions by the ultra-low volume method, or to inject the composition as a composition or as sole-compositions into the soil (in-furrow).

The term “plant to be treated” encompasses every part of a plant including its root system and the material—e.g., soil or nutrition medium—which is in a radius of at least 10 cm, 20 cm, 30 cm around the caulis or bole of a plant to be treated or which is at least 10 cm, 20 cm, 30 cm around the root system of said plant to be treated, respectively.

The application rate of the compositions for increasing the growth of plants to be employed or used may vary. A person of skill would be able to ascertain the appropriate application rate by way of routine experiments.

According to aspects of the invention, all plants and plant parts can be treated. The term “plants” means all plants and plant populations, which includes, desirable and undesirable wild plants, cultivars and plant varieties (whether or not protectable by plant variety or plant breeder's rights). Cultivars and plant varieties can be plants obtained by conventional propagation and breeding methods, which can be assisted or supplemented by one or more biotechnological methods such as by use of double haploids, protoplast fusion, random and directed mutagenesis, CRISPR/Cas, grafting, RNAi, molecular and/or genetic markers, and/or by bioengineering and genetic engineering methods. The term “plant parts” means all above ground and below ground parts and organs of plants such as shoot, leaf, blossom and root, whereby for example leaves, needles, stems, branches, blossoms, fruiting bodies, fruits and seed as well as roots, corms and rhizomes are listed. Crops and vegetative and generative propagating material, for example cuttings, corms, rhizomes, runners and seeds also belong to plant parts.

The described benzoxaborole compounds and compositions, while they are well tolerated by plants, are used in amounts which are non-phytotoxic with respect to the plant being treated but which enhance growth of the plant or certain parts thereof. The benzoxaborole compounds and compositions that induce growth enhancing effects within plants, which results in superior growth of these treated plants, increases crop yield, improves quality, increases longevity of harvested parts thereof, and/or enhance nutrient content are well tolerated by the environment, are suitable for protecting plants and plant organs, enhancing harvest yields, and improving the quality of the harvested material. The compounds and compositions may also function as a crop protection compound or composition. Moreover, the compounds and/or compositions are active against tolerant species that normally sensitive, affecting all or some stages of development.

The benzoxaborole compounds and compositions may also have antimicrobial activity, that works with the growth enhancing properties to produce a plant, plant parts, or plant propagation materials with increased yield, vigor, size, and post-harvest quality and/or longevity.

In some embodiments, the benzoxaborole compositions may comprise fertilizers or plant stimulants. Examples of fertilizers include, granular, slow release granular, and liquid formulations of combinations of the macronutrients nitrogen, phosphorus, and potassium (N—P—K) as well as granular, slow-release granular, and liquid for micronutirents such as calcium and/or magnesium. In some embodiments, the fertilizer is a water-soluble boron fertilizer such as boric acid or a borate. Such compositions enhance plant growth relative to traditional fertilizer application alone. In some benzoxaborole compositions, the benzoxaborole is a slow releasing complex of an active boron fragment. These slow releasing complexes prolong the length of time where the applied composition induces growth enhancing effects on plants and plant parts. In some benzoxaborole compositions, the presence of a benzoxaborole can reduce the amount of non-benzoxaborole fertilizers or plant stimulants needed to achieve the desired affect (achieving similar desirable growth enhancing effect on plants or plant parts using less non-benzoxaborole fertilizer). Plant stimulants operate through different mechanisms than fertilizers, regardless of the presence of other plant nutrients in the product composition. Plant stimulants differ from crop protection products due to the fact that they only have an effect on the plant vigor and growth and no direct action against plant pests.

Examples of plant stimulants include fatty acids, plant-growth promoting microorganisms, recycled plant material, humic substances, complex organic materials, and hydrolyzed proteins and amino acids.

In some embodiments, the benzoxaborole composition comprises a pest controlling agent or at least one pest controlling agent. Pest controlling agents include: fungicides, herbicides, insecticides, nematicides, or combinations thereof.

Benzoxaborole compositions that comprise a pest controlling agent are advantageous in that a greater overall improvement on plant health and vigor is achieved since the benzoxaborole composition is pest controlling and provides a growth enhancing effect. In other embodiments of the benzoxaborole composition, the benzoxaborole compound is the pest controlling agent. For example, in some embodiments, the benzoxaborole is antimicrobial. In these instances, the benzoxaborole is both an antimicrobial agent and a provides a growth enhancing effect. Such compositions are advantageous in that a single compound can provide antimicrobial and growth enhancing affects.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations, and even initially claimed as such, one or more features from a claimed combination can in some cases be excised from the combination, and the claimed combination may be directed to a sub-combination or variation of a sub-combinations.

### EXAMPLES

### Example 1 (Prophetic): Growth Enhancing Effect on Soy and Wheat

In experiments to be conducted on plant materials, specifically soybeans and wheat seeds, benzoxaborole compounds and/or compositions are tested for their effect on plant growth.

In each of the below experiments, different rates of a benzoxaborole compound or composition are used to evaluate the growth enhancing ability (both negative and positive effects) of the applied chemical compounds relative to an untreated control. Below is the rate table of compounds to be used:

TABLE 1
General experimental protocol

| | Label | Trial Rate | Trial Rate | Trial Rate | Trial Rate | Trial Rate | Spray | Total |
|---|---|---|---|---|---|---|---|---|
| Compound | Rate | 1x | 0.5x | 0.25x | 0.125x | 0.0625x | Rate | Volume |
| Benzoxaborole | 0.5 lb/A | 5.2 mg/ft² | 2.6 mg/ft² | 1.3 mg/ft² | 0.65 mg/ft² | 0.325 mg/ft² | 20 gal/A | 40 mL |

### Wheat:

Growth Conditions:

Wheat seeds (spring wheat) are sown into 4-inch diameter plastic pots to 5 centimeters below the top with professional potting mix in a sanitized BSL-2 containment greenhouse. All seedlings are subjected to 12 hours of daylight at ˜800 μmol/m²/second (light intensity). Daytime temperatures are ˜26° C. and are dropped to ˜21° C. at night.

Eight wheat seeds are placed onto the soil surface. The seeds are covered with approximately 4 centimeters of soil, leaving the soil approximately 1 centimeter below the top of the pot. The seeds are watered until soil is completely moist. As the plants emerged, 5 shoots are removed. The plants are measured at the beginning of tillering and between 1-10 mL of compound solution is added to each pot, soaking until soil is wet.

The plants are evaluated every 7 days following the initial measurement until plants reach maturity (approximately 90 days after emergence).

Once plants reach the booting stage (when head is forming in the sheath and beginning to emerge from the sheath), a second round of compound solution is applied. The growth conditions are maintained until the plants reach maturity, when final recordings are taken. It is expected that as a result of the treatment, a benzoxaborole compound and/or composition will display an enhanced growth effect relative to an untreated control.

### Soybean:

### Growth Conditions:

Soybean seeds are sown into 6-inch diameter plastic pots containing professional potting mix in a sanitized BSL-2 containment greenhouse. All seedlings are subjected to 12 hours of daylight at ˜800 μmol/m²/second (light intensity). Daytime temperatures are ˜28° C. and are dropped to ˜25° C. at night.

Two soybean seeds are placed per pot, approximately 4 centimeters below the soil surface. The seeds are watered until soil is completely moist. As the plants emerge, 5 shoots are removed. When plants reach growth stage V2, between 1-10 mL of compound solution is added to each pot, soaking until soil is wet. 10 days after the initial application of compound solution, the height of each plant is recorded, measured from the soil line to tallest leaf node.

Once plants reached full flowering, a second application of compound solution is applied. One day prior to the second compound solution application, the height of plants is recorded again.

One day after the second data collection, between 1-10 mL of compound solution is added to each pot, soaking until soil is wet. At full pod stage, number of pods per plant and number of nodes which have pods are recorded.

The growth conditions are maintained until the plants reach maturity, when final recordings are taken. It is expected that as a result of the treatment, a benzoxaborole compound and/or composition will display an enhanced growth effect relative to the untreated control.

### Example 2: Soil Drench Growth Enhancing Effect

Growth Conditions:

Boron-containing compounds/compositions were applied directly to the soil, and the growth of plants was measured. An exemplary embodiment of a benzoxaborole compound includes 5-chlorobenzo[c][1,2]oxaborol-1(3H)-ol, which may be referred to herein as BAG8.

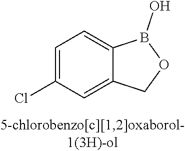 [SMILES: OB1OCc2cc(Cl)ccc21]

Unless stated otherwise, BAG8 was used as the benzoxaborole compound for the examples described herein.

Eight 2-gallon pots were filled with steamed soil for each of the five treatments listed below:

TABLE 2

| | | | | Amount | |
|---|---|---|---|---|---|
| | | | | ethanol to | Amount |
| | Rates | Total | Amount of | dissolve in | distilled |
| Treatments | in lb/A | mixing vol | compound | (10%) | water to add |
| A | 0 | 900 mL | 0 | 90 mL | 810 mL |
| B | 0.12 | 900 mL | 3.1 mg | 90 mL | 810 mL |
| C | 0.25 | 900 mL | 6.4 mg | 90 mL | 810 mL |
| D | 0.35 | 900 mL | 8.9 mg | 90 mL | 810 mL |
| E | 0.60 | 900 mL | 15.3 mg | 90 mL | 810 mL |

3-4 seeds were planted into each pot at a depth of 1 inch and covered. All seedlings were subjected to 16 hours of daylight at ˜800 μmol/m²/second (light intensity) provided by cool-white fluorescent lamps. Daytime temperatures were ˜25° C. and were dropped to ˜18° C. at night.

Solutions were prepared by first dissolving the appropriate amount of benzoxaborole in ethanol or acetone then adding to distilled water. 100 mL of treatment was applied to each pot in a circular motion to evenly coat the surface of the soil. These treatments were applied every 14 days for a total of 4 treatments, including the at-planting treatment. Each pot was monitored, and 50 mL of distilled water was added to each pot when soil was dry.

Germination and shoot height data were recorded every seven days. 14 days after the final treatment application, plants were carefully removed from each pot and final shoot length, root length, and dry matter weight were recorded.

This experiment was conducted on red table beet, broccoli, snow pea, turnips, and spring wheat.

Red Table Beet treated with benzoxaborole composition, namely, BAGS:

TABLE 3

| | Average Shoot | Average Root | Average Dry Matter |
|---|---|---|---|
| | Height (cm) | Length (cm) | Weight (mg) |
| A | 2.96 | 3.34 | 9.50 |
| B | 3.33 | 4.50 | 10.70 |
| C | 4.24 | 5.98 | 11.10 |
| D | 4.09 | 5.56 | 11.30 |
| E | 5.01 | 5.15 | 13.00 |

As a result of the treatments, red table beet seedling average shoot height, average root length, and dry matter weight had a positive correlation with application rates of BAG8. All application rates of BAG8 produced longer shoots, longer roots, and greater dry matter weight than the untreated control. As seen in Table 3, red table beet seedlings displayed beneficial growth effect results following application with BAG8 at all rates tested.

Broccoli treated with BAG8:

TABLE 4

| | Average Shoot | Average Root | Average Dry Matter |
|---|---|---|---|
| | Height (cm) | Length (cm) | Weight (mg) |
| A | 4.50 | 4.60 | 9.50 |
| B | 4.50 | 5.60 | 10.70 |
| C | 4.40 | 5.20 | 11.10 |
| D | 4.90 | 5.30 | 11.30 |
| E | 4.50 | 6.50 | 13.00 |

As a result of the treatments, broccoli seedling average root length and dry matter weight had a positive correlation with application rates of BAG8. All rates of BAG8 produced longer roots and greater dry matter weight than the untreated control. Conversely, the results suggest that no treatment effect was present for average shoot height under these conditions. Though shoot height was not affected by treatment under these conditions, broccoli displayed beneficial growth effect results in terms of root length and dry matter weight following application with BAG8.

Snow Peas treated with BAG8:

TABLE 5

| | Average Shoot | Average Root | Average Dry Matter |
|---|---|---|---|
| | Height (cm) | Length (cm) | Weight (mg) |
| A | 11.90 | 11.90 | 168.50 |
| B | 6.90 | 7.10 | 102.70 |
| C | 13.10 | 12.10 | 280.10 |
| D | 9.40 | 8.00 | 185.70 |
| E | 6.50 | 7.90 | 130.90 |

Under these conditions, the application of BAG8 to snow pea seedlings does not increase average shoot height, average root length, or average dry matter weight compared to an untreated control, with the exception of BAG8 applied at a rate of 0.25 pounds per acre. When applied to snow peas at a rate of 0.25 pounds per acre, BAG8 increased the shoot height, root length, and dry matter weight.

Turnip treated with BAG8:

TABLE 6

| | Average Shoot | Average Root | Average Dry Matter |
|---|---|---|---|
| | Height (cm) | Length (cm) | Weight (mg) |
| A | 1.52 | 1.86 | 6.05 |
| B | 1.81 | 3.67 | 6.40 |
| C | 2.09 | 4.96 | 7.62 |
| D | 2.18 | 4.02 | 7.82 |
| E | 2.13 | 3.15 | 6.36 |

As a result of the treatments, turnip seedling average shoot height, average root length, and dry matter weight had a positive correlation with rates of BAG8. All rates of BAG8 produced longer shoots, longer roots, and greater dry matter weight than the untreated control. Turnip seedlings displayed beneficial growth effect results following application with BAG8 at all rates tested.

Wheat treated with BAG8:

TABLE 7

| | Average Shoot | Average Root | Average Dry Matter |
|---|---|---|---|
| | Height (cm) | Length (cm) | Weight (mg) |
| A | 35.10 | 18.80 | 476.40 |
| B | 39.50 | 21.30 | 1204.30 |
| C | 39.70 | 24.40 | 1123.60 |
| D | 37.50 | 20.40 | 640.20 |
| E | 39.90 | 22.00 | 649.70 |

As a result of the treatments, wheat seedling average shoot height, average root length, and dry matter weight had a significant positive correlation with rates of BAG8. All rates of BAG8 produced longer shoots, longer roots, and greater dry matter weight than the untreated control. Wheat seedlings displayed beneficial growth effect results following application with BAG8 at all rates tested. In fact, BAG8 applied at 0.12 and 0.25 pounds per acre displayed nearly 250% increase in final dry matter weight of wheat.

### Example 3 (Prophetic): Hydroponic Benzoxaborole Growth Effect Study Protocol

### Protocol Example

Growth Conditions:

Seeds are planted into flats of rockwool cubes. Flats are placed in a deionized water intermittent mist bed. All seedlings are subjected to 12-16 hours of daylight at ˜800 μmol/m²/second (light intensity) provided by cool-white fluorescent lamps. Daytime temperatures are ˜25° C., which are dropped to ˜18° C. at night.

Eighteen days following sowing, seedling plugs are transplanted to Grodan expert 20/75 slabs. Each slab is made of UV-resistant polyethylene material with dimensions of 8×48 inches (˜3 ft² surface). Three plugs are transplanted into each bag at a spacing of 16 inches apart.

Each plant has a solution emitter installed near the stem to deliver water and a modified Hoagland solution minus the boron composition for three minutes every thirty minutes, thus delivering approximately 1 liter of solution per line per application. Hoagland solution is maintained in plastic containers and dosed into the water line via a Dosatron D25 pump and Dosatron Hi-Ho 1″ dosing system producing a dosing rate of 20 liters per hour.

Eleven slabs are installed per bench (replicates) for a total of 33 plants per bench (one bench equals one replication). Each treatment is applied to one slab (three plants) using the treatment rates listed in the table below (lx, 0.5×, 0.25×, 0.125×, 0.0625×) plus an untreated control slab. In Table 8, label rate is the amount of active ingredient per planted area, trial rate is a conversion from label rate to the rate of active ingredient used for testing (dimensional analysis), and spray rate is the total volume of liquid applied. A total of three benches (replications) were used in each experiment for a total of 9 plants per treatment per experiment.

TABLE 8

| Compound/ | Label | Trial Rate | Trial Rate | Trial Rate | Trial Rate | Trial Rate | Spray | Total |
|---|---|---|---|---|---|---|---|---|
| Composition | Rate | 1x | 0.5x | 0.25x | 0.125x | 0.0625x | Rate | Volume |
| BAG8 | 0.5 lb/A | 5.2 mg/ft² | 2.6 mg/ft² | 1.3 mg/ft² | 0.65 mg/ft² | 0.325 mg/ft² | 20 gal/A | 1 L |

Soil Application of Treatments:

A one-time treatment is applied via soil drench to the roots one week following transplanting into Grodan slabs. The treatment rates of BAG8 from the above table are delivered in 1 L of Hoagland solution to the corresponding slab for each treatment.

Foliar Application of Treatments:

At the flowering stage, foliar applications of each of the respective rates are applied to each plant with a hand-held spray bottle and sprayed until just before running off. To prevent contamination of plant roots and growth medium with the foliar spray treatment, each slab is taken to a separate area before treatment and the slabs and plants up to the first leaves are protected by securing a 100 L plastic bag tight around each stem in the slab. A new bag is used for each container and each time a treatment is applied.

Plant heights are recorded from the base of the stem to the most apical leaf node seven days post application and every seven days for the remainder of the experiment.

Growth conditions are maintained until the plants are harvested and final recordings are taken

Approximately 60 days after transplanting, plants are harvested, and for plants which produced vegetative fruit, yield, fruit quality, and fruit size are recorded. Following harvest, plants are removed from the hydroponic system, weighed, dried at 70° C. for 72 hours and reweighed.

This protocol is used to conduct experiments on alfalfa, canola, tomato, bell pepper, wheat, and barley. Each experiment is repeated three times. As a result of the treatment, BAG8 is expected to display an enhanced growth affect relative to the untreated control.

### Example 4: Growth Effect of Benzoxaborole Compound on Maize

A sample suspension concentrate was prepared by mixing 0.8 g of Atlas G-5002L, 0.8 g ATLOX 4913, 5 g of glycerin, 50 mg of anti-foam compound, 0.178 g of xanthan gum, 89 mg of anti-microbial, 53.08 g of water, and 40 g of BAG8. 2.3 mg, 4.6 mg, and 6.9 mg of suspension concentrate was added to three separate vials of 261 mg of water and shaken vigorously to produce samples that could be used for seed treatment application at rates of 0.25 g/A, 0.5 g/A, and 0.75 g/A respectively. To treat seeds, 100 g of maize seeds were added to a lidded container with either 0.263 g of 0.25 g/A formulation, 0.265 g of 0.5 g/A formulation, or 0.267 g of 0.75 g/A formulation. The container was then shaken to evenly coat the seeds and allowed to dry overnight. Once dry, 50 seeds from each rate and 50 untreated seeds were placed in separate seed germination trays with moist paper towel. 10 days later, root and stem lengths from each seed were taken. Analysis of variance was used to examine root and stem length data and means were separated using Fisher's least significant difference at α=0.05. Root and stem lengths are presented in Table 9.

TABLE 9
Mean root and stem lengths (mm) from
BAG8 treatments on maize seeds

| Treatment | Mean Root Length (mm) | | Mean Stem Length (mm) | |
|---|---|---|---|---|
| Untreated Control | 73.9 | b* | 80.8 | b |
| BAG8 0.25 lb ai/A | 122.0 | a | 141.0 | a |
| BAG8 0.50 lb ai/A | 110.2 | a | 124.5 | a |
| BAG8 0.75 lb ai/A | 125.1 | a | 136.5 | a |

*Means followed by the same letter are not significantly different from each other (α = 0.05).

As is evident in table 9, all tested application rates of BAG8 significantly increased both root and stem length relative to untreated control. BAG8 increased root length from 49-70% and increased stem length from 54-75%.

### Example 5: Growth Enhancing Effect of Benzoxaborole Compound on Wheat, Canola, and Soy—Soil Drench Treatment

### Preparation of Benzoxaborole Soil Drench Solutions

Sample soil drench treatments were prepared by dissolving 2.31 mg, 3.19 mg, or 3.99 mg of BAG8 in 67.5 mL of acetone in separate vials. Each vial was then added to 202.5 mL of water and shaken vigorously to produce a suitable sample for soil drench treatment at rates of 75 g/A, 100 g/A, and 125 g/A, respectively.

### Wheat

Wheat seeds were sown into pots filled with perlite growth medium and allowed to germinate under normal glass house conditions. 10 days after germination the pots were drenched with the respective BAG8 solutions. 10 days following the drench, root and stem lengths were measured. Analysis of variance was used to examine root length data and means were separated using Fisher's least significant difference at α=0.05. Root lengths are presented in Table 10.

TABLE 10
Mean root lengths (mm) from BAG8 soil
drench treatments on wheat seedlings

| Treatment | Mean Root Length (mm) | |
|---|---|---|
| Untreated Control | 399.7 | b* |
| BAG8 75 g ai/A | 580.4 | a |
| BAG8 100 g ai/A | 524.2 | a |
| BAG8 125 g ai/A | 507.0 | a |

*Means followed by the same letter are not significantly different from each other (α = 0.05).

As is evident in table 10, all tested application rates of BAG8 significantly increased root length relative to untreated control when applied as a soil drench to wheat seedlings. BAG8 increased root length from 27-45%.

### Canola

Canola seeds were sown into pots filled with perlite growth medium and allowed to germinate under normal glass house conditions. 10 days after germination the pots were drenched with the respective BAG8 solutions. 10 days following the drench, stem lengths were measured. Analysis of variance was used to examine stem length data and means were separated using Fisher's least significant difference at α=0.05. Stem lengths are presented in Table 11.

TABLE 11
Mean stem lengths (mm) from BAG8 soil
drench treatments on canola seedlings

| Treatment | Mean Stem Length (mm) | |
|---|---|---|
| Untreated Control | 28.6 | d* |
| BAG8 75 g ai/A | 39.2 | b |
| BAG8 100 g ai/A | 33.8 | c |
| BAG8 125 g ai/A | 47.1 | a |

*Means followed by the same letter are not significantly different from each other (α = 0.05).

As is evident in table 11, all tested application rates of BAG8 significantly increased stem length relative to untreated control when applied as a soil drench to canola seedlings. BAG8 increased root length from 19-65%.

### Soybean

Soybean seeds were sown into pots filled with perlite growth medium and allowed to germinate under normal glass house conditions. 10 days after germination the pots were drenched with the respective BAG8 solutions. 10 days following the drench, root lengths were measured. Analysis of variance was used to examine stem length data and means were separated using Fisher's least significant difference at α=0.05. Stem lengths are presented in Table 12.

TABLE 12
Mean root lengths (mm) from BAG8 soil
drench treatments on soybean seedlings

| Treatment | Mean Root Length (mm) | |
|---|---|---|
| Untreated Control | 260.1. | b* |
| BAG8 75 g ai/A | 329.5 | a |
| BAG8 100 g ai/A | 275.8 | ab |
| BAG8 125 g ai/A | 309.7 | a |

*Means followed by the same letter are not significantly different from each other (α = 0.05).

As is evident in table 12, all tested application rates of BAG8 significantly increased stem length relative to untreated control when applied as a soil drench to canola seedlings. BAG8 increased root length from 6-27%.

### Example 6: Growth Enhancing Effect of BAG8 Compound on Diseased Soybean

Soybeans Treated with BAG8 and Azoxystrobin

In this example, diseased soybeans having Asian Soybean Rust (Phakopsora pachyrhizi) were treated with BAG8 and Azoxystrobin. Testing was performed to assess the fungicidal effect of the compounds on Asian Soybean Rust and to assess the growth enhancing effects of the compounds on the diseased soybeans.

Soybeans were planted into 6×30 ft plots and replicated four times in a randomized complete block design. Two treatments and an untreated control were tested for efficacy against Asian Soybean Rust (Phakopsora pachyrhizi) and assessed for yield at the conclusion of the growing season. Foliar applications of the two treatments, BAG8 at 0.25 pounds of active ingredient per acre and azoxystrobin at 0.25 pounds of active ingredient per acre, were applied to the plots at two separate times: growth stage R1 (flowering) and growth stage R3 (bean pod formation). Best practices were used consistently across the test plots with regard to field conditions such as fertilization, insect control, weed control, and irrigation. Disease assessments were taken in each plot 28 days after the final foliar fungicide application. At maturity, each plot was harvested using standard harvesting equipment. After shelling, the beans were weighed at 13% moisture and yield calculations extrapolated to bushels per acre.

Analysis of variance (ANOVA) was used to examine disease severity data and means were separated using Fisher's least significant difference (LSD) method at α=0.05. Disease and yield data are presented below in Table 13.

TABLE 13
Mean Asian Soybean Rust severity and yield from
BAG8 and azoxystrobin treatments on soybean.

| | Disease Severity | Yield |
|---|---|---|
| Treatment | (% Leaf Coverage) | (bu/A) |
| Untreated Control | 90.9 a* | 14.6 f |
| BAG8 @ 0.25 lb ai/A | 48.2 c | 55.6 a |
| Azoxystrobin @ 0.25 lb ai/A | 30.6 d | 59.2 a |

*Means followed by the same letter are not significantly different from each other (α = 0.05).

As Table 13 shows, BAG8 and Azoxystrobin had a fungicidal effect. According to the data, Azoxystrobin had a greater fungicidal effect. In comparison to untreated control, BAG8 reduced disease by 47%, and azoxystrobin reduced disease by 66%. However, the yields from plots treated with BAG8 and the yields from plots treated with azoxystrobin were not statistically different. BAG8 increased soybean yield by 281%, and azoxystrobin increased soybean yield by 305%. The data indicates that BAG8 provided a growth effect to soybeans in addition to a fungicidal effect. BAG8 was not as effective at controlling Asian Soybean Rust as azoxystrobin, but the application of BAG8 gave yields that were statistically indistinguishable from azoxystrobin. Thus, BAG8 provided a growth effect to soybeans that was outside of the parameters of solely protecting the plants from fungal infection.

### Example 7: Growth Enhancing Effect of BAG8 Compound on Diseased Maize

Maize Treated with BAG8, Azoxystrobin, and Boscalid

In this example, diseased maize having Southern Rust of Maize (Puccinia polysora) was treated with BAG8, Azoxystrobin, and Boscalid. Testing was performed to assess the fungicidal effect of the compounds on Southern Rust of Maize (Puccinia polysora) and to assess the growth enhancing effect of the compounds on the diseased maize.

Maize was planted into 6×30 ft plots and replicated four times in a randomized complete block design. Three treatments and an untreated control were tested for efficacy against Southern Rust of Maize (Puccinia polysora) and assessed for yield at the conclusion of the growing season. Foliar applications of the three treatments, BAG8 at 0.25 pounds of active ingredient per acre, azoxystrobin at 0.25 pounds of active ingredient per acre, and boscalid at 0.24 pounds of active ingredient per acre, were applied to the plots at growth stage V8. Best practices were used consistently across the test plots with regard to field conditions such as fertilization, insect control, weed control, and irrigation. Disease assessments were taken in each plot 28 days after the foliar fungicide application. At maturity, each plot was harvested using standard harvesting equipment. After shelling, the kernels were weighed at 11% moisture and yield calculations extrapolated to bushels per acre.

Analysis of variance (ANOVA) was used to examine disease severity data and means were separated using Fisher's least significant difference (LSD) method at α=0.05. Disease and yield data are presented below in Table 14.

TABLE 14
Mean Southern Rust of Maize severity and yield (bushels/acre)
from BAG8, azoxystrobin, and boscalid treatments on maize.

| | Disease Severity | Yield |
|---|---|---|
| Treatment | (% Leaf Coverage) | (bu/A) |
| Untreated Control | 65.3 a* | 49.7 d |
| BAG8 @ 0.25 lb ai/A | 19.6 b | 146.2 a |
| Azoxystrobin @ 0.25 lb ai/A | 0.0 c | 151.1 a |
| Boscalid @ 0.24 lb ai/A | 25.1 b | 91.6 c |

*Means followed by the same letter are not significantly different from each other (α = 0.05).

As Table 14 shows, BAG8, Azoxystrobin, and Boscalid had a fungicidal effect. Azoxystrobin was the most efficacious. Relative to the untreated control, BAG8 reduced disease by 70%, and azoxystrobin reduced disease by 100%. BAG8 and boscalid were statistically identical in their reduction of disease.

However, yields from plots treated with BAG8 and yields from plots treated with azoxystrobin were not statistically different. Relative to untreated control, BAG8 increased yield by 194% and azoxystrobin increased yield by 205%. Furthermore, the yields from maize plots treated with boscalid were significantly lower than those from plots treated with BAG8 or azoxystrobin. BAG8 was not as effective at controlling Southern Rust of Maize as azoxystrobin, but the application of BAG8 gave yields that were statistically indistinguishable from azoxystrobin. Moreover, BAG8 and boscalid provided the same statistical level of disease control, but plots treated with BAG8 gave significantly and statistically higher yield. Accordingly, BAG8 provided a growth effect to maize that is outside of the parameters of solely protecting the plants from fungal infection.

Particular implementations of the subject matter have been described above. Other implementations, alterations, and permutations of the described implementations are within the scope of the following claims as will be apparent to those skilled in the art. For example, the actions recited in the claims can be performed in a different order and still achieve desirable results.

Accordingly, the above description of example implementations does not define or constrain this disclosure. Other changes, substitutions, and alterations are also possible without departing from the spirit and scope of this disclosure.

A number of embodiments of the present disclosure have been described. While this specification contains many specific implementation details, the specific implementation details should not be construed as limitations on the scope of any disclosures or of what may be claimed, but rather as descriptions of features specific to particular embodiments of the present disclosure.

Certain features that are described in this specification in the context of separate embodiments can also be implemented in combination in a single embodiment. Conversely, various features that are described in the context of a single embodiment can also be implemented in combination in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

In certain implementations, multitasking and parallel processing may be advantageous. Nevertheless, it will be understood that various modifications may be made without departing from the spirit and scope of the claimed disclosure.

1. A plant growth enhancing benzoxaborole compound comprising:
a benzoxaborole of structure I: 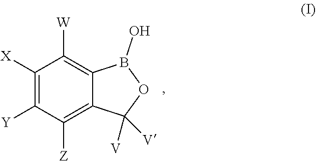
wherein:
W is selected from the group consisting of: hydrogen, halogen, CH₃, CF₃, Et, OCH₃, OCF₃, OCF₂H, CFH₂, OEt, SR¹, and S(O)R¹, wherein R¹ is selected from C1-C3 hydrocarbyl;
X is selected from the group consisting of: hydrogen, R², OR², NR²₂, NHR², NH₂, halogen, CO₂R², CN, OH, CH₂OH, NO₂, SR², and S(O)R²,
wherein each R² is independently selected from C1-C5 hydrocarbyl and C3-C5 cyclohydrocarbyl;
Y is selected from the group consisting of: hydrogen, halogen, and CO₂R³, wherein R³ is selected from C1-C4 hydrocarbyl and C3-C4 cyclohydrocarbyl;
Z is selected from the group consisting of: hydrogen, halogen, R⁴, NR⁴₂, NHR⁴, NH₂, CO₂R⁴, OR⁴, OH, SR⁴, and S(O)R⁴, wherein R⁴ is selected from C1-C3 hydrocarbyl and C3 cyclohydrocarbyl; and
V and V′ are independently selected from the group consisting of hydrogen and CH₃;
or a salt, agricultural chemical salt, pharmaceutical salt, stereoisomer, enantiomer, or tautomer thereof, and
wherein the benzoxaborole composition induces a growth enhancing effect within plants.

2. The plant growth enhancing benzoxaborole compound of claim 1, wherein the benzoxaborole has a structure (Ia): 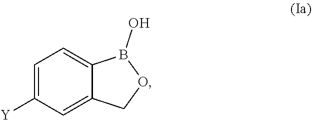
wherein Y is halogen
or a salt, agricultural chemical salt, pharmaceutical salt, stereoisomer, enantiomer, or tautomer thereof.

3. The benzoxaborole compound of claim 1, wherein the benzoxaborole has a structure (Ib): 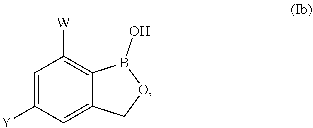
wherein Y and W are halogen and independently selected from the group consisting of: fluorine, chlorine, bromine, and iodine
or a salt, agricultural chemical salt, pharmaceutical salt, stereoisomer, enantiomer, or tautomer thereof.

4. The benzoxaborole compound of claim 1, wherein the benzoxaborole has a structure, Ia: 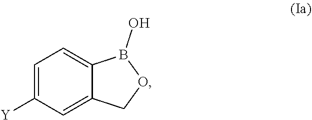
wherein Y is chlorine
or a salt, agricultural chemical salt, pharmaceutical salt, stereoisomer, enantiomer, or tautomer thereof.

5. The compound of claim 1, wherein the composition may be administered systemically, topically, in the soil, as a seed treatment, or as a foliar spray.

6. The compound of claim 1, wherein the composition is administered as a nutritive supplement for plant growth in an indoor growing environment.

7. The compound of claim 1, wherein administration of the composition increases vigor and yield.

8. The compound of claim 1, wherein administration of the composition to the plant results in prolonged shelf-life of the harvested plant, or plant parts.

9. The compound of claim 1, wherein the benzoxaborole composition is a slow releasing complex containing an active boron fragment, and wherein the active boron fragment induces the growth enhancing effect within plants.

10. The compound of claim 1, wherein the benzoxaborole composition is a pesticide.

11. The compound of claim 1, further comprising a fertilizer and/or a plant stimulant.

12. The compound of claim 11, wherein the fertilizer comprises a borate and/or boric acid.

13. The compound of claim 11, wherein the composition is applied more than once and a time duration between applications of the composition comprising the fertilizer is longer than the time duration between applications of borate or boric acid alone.

14. The compound of claim 1, further comprising a pest controlling agent.

15. The compound of claim 14, wherein the pest controlling agent comprises a fungicide, a herbicide, an insecticide, an antimicrobial, a nematicide, or a combination thereof.

16. The compound of claim 1, wherein the benzoxaborole is a fungicide.

17. The compound of claim 1, wherein the benzoxaborole composition is applied immediately before or at a flowering stage of plant growth to enhance the yield, mass, or sugar content of plant propagation materials.

18. A method of enhancing the growth of a plant, plant part, plant propagation material, or a fruit harvested therefrom, comprising applying an effective amount of a benzoxaborole compound, the benzoxaborole compound comprising a benzoxaborole of structure I: 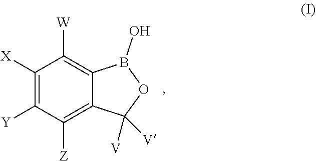
wherein:
W is selected from the group consisting of: hydrogen, halogen, CH₃, CF₃, Et, OCH₃, OCF₃, OCF₂H, CFH₂, OEt, SR¹, and S(O)R¹, wherein R¹ is selected from C1-C3 hydrocarbyl;
X is selected from the group consisting of: hydrogen, R², OR², NR²₂, NHR², NH₂, halogen, CO₂R², CN, OH, CH₂OH, NO₂, SR², and S(O)R²,
wherein each R² is independently selected from C1-C5 hydrocarbyl and C3-C5 cyclohydrocarbyl;
Y is selected from the group consisting of: hydrogen, halogen, and CO₂R³, wherein R³ is selected from C1-C4 hydrocarbyl and C3-C4 cyclohydrocarbyl;
Z is selected from the group consisting of: hydrogen, halogen, R⁴, NR⁴₂, NHR⁴, NH₂, CO₂R⁴, OR⁴, OH, SR⁴, and S(O)R⁴, wherein R⁴ is selected from C1-C3 hydrocarbyl and C3 cyclohydrocarbyl; and
V and V′ are independently selected from the group consisting of hydrogen and CH₃;
or a salt, agricultural chemical salt, pharmaceutical salt, stereoisomer, enantiomer, or tautomer thereof, and
wherein the benzoxaborole composition induces a growth enhancing effect within plants.

19. The method of claim 18, wherein the benzoxaborole has a structure (Ia): 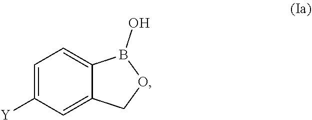
wherein Y is halogen
or a salt, agricultural chemical salt, pharmaceutical salt, stereoisomer, enantiomer, or tautomer thereof.

20. The method of claim 18, wherein the benzoxaborole has a structure (Ib): 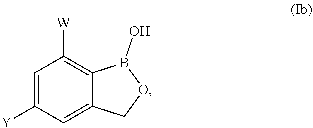
wherein Y and W are halogen and independently selected from the group consisting of: fluorine, chlorine, bromine, and iodine
or a salt, agricultural chemical salt, pharmaceutical salt, stereoisomer, enantiomer, or tautomer thereof.

21. The method of claim 18, wherein the benzoxaborole has a structure, (Ia): 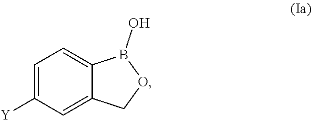
wherein Y is chlorine
or a salt, agricultural chemical salt, pharmaceutical salt, stereoisomer, enantiomer, or tautomer thereof.

22. The method of claim 18, wherein the compound is applied topically, systemically, foliarly, to the soil, or as a seed treatment.

23. The method of claim 18, wherein the compound is administered as a nutritive supplement for plant growth in an indoor growing environment.

24. The method of claim 18, wherein applying the compound increases vigor and yield.

25. The method of claim 18, wherein applying the compound to a plant results in prolonged shelf-life of the harvested plant, or plant parts.

26. The method of claim 18, further comprising applying the compound more than one time.

27. The method of claim 18, wherein the compound is applied immediately before or at a flowering stage of plant growth to enhance the yield, mass, or sugar content of plant propagation materials.
